(19) United States
(12) Patent Application Publication
(10) Pub. No.: US 2025/0337080 A1
(43) Pub. Date: Oct. 30, 2025

(54) SUPPORT STRUCTURE OF BATTERY

(71) Applicant: ISUZU MOTORS LIMITED, Yokohama-shi (JP)

(72) Inventor: Takahiro SEKIUCHI, Fujisawa-shi (JP)

(21) Appl. No.: 19/033,110

(22) Filed: Jan. 21, 2025

(30) Foreign Application Priority Data
Apr. 30, 2024 (JP) 2024-073924

(51) Int. Cl. H01M 50/249; H01M 50/242; H01M 50/264

(52) U.S. Cl. CPC H01M 50/249; H01M 50/242; H01M 50/264

(57) ABSTRACT

A battery support structure supporting a driving battery that supplies electric power to drive a motor. The battery support structure includes the following: a pair of frames disposed to be separated from each other in a vehicle width direction of a vehicle; a mounting table on which the battery is placed and which is attached on the frame on an outer side in the vehicle width direction; a first cross member mounted between the pair of frames at a predetermined position in the vehicle front-rear direction where the mounting table is attached; and a second cross member disposed at a position higher than that of the first cross member and mounted between the pair of frames.

This application is entitled to (or claims) the benefit of Japanese Patent Application No. 2024-073924, filed on Apr. 30, 2024, the disclosure of which including the specification, drawings and abstract is incorporated herein by reference in its entirety.

### TECHNICAL FIELD

The present disclosure relates to a support structure of a battery (herein also simply referred to as “battery support structure”).

### BACKGROUND ART

Vehicles such as electric vehicles and plug-in hybrid vehicles are equipped with an electric motor as a drive source and a driving battery that drives the electric motor. A battery mounted on such a vehicle is heavy and therefore require large force for supporting the battery. As a result, the battery is supported by a vehicle body or a frame, which has great strength.

As a support structure of a battery and/or an electric motor, for example, PTL 1 describes an electric vehicle including left and right front wheels and left and right rear wheels. The vehicle of PTL 1 includes the following: a lower frame including left and right side frames extending in the front-rear direction and a cross member extending in the left-right direction to connect the left and right side frames to each other; a seat-supporting front member and a seat-supporting rear member disposed on the lower frame between the front and rear wheels; a seat supported by the seat-supporting front member and seat-supporting rear member; a front suspension device that is provided on the side frame and suspends a front wheel; a rear suspension device that is provided on the side frame and suspends a rear wheel; an electric motor that drives the rear wheels and is disposed between the left and right rear wheels and the left and right side frames; a battery that is disposed between the left and right side frames including under the seat; and a power control unit that is disposed between the left and right side frames between the battery and the electric motor and receives power from the battery unit and controls the electric power supplied to the electric motor.

In addition, for example, PTL 2 describes a vehicle body structure of an electric vehicle in which a battery unit including a battery is fixed to a vehicle body frame including a pair of side members extending in the front-rear direction of the vehicle, and one end of a trailing arm is coupled to the vehicle body frame so as to be capable of swaying. In the vehicle body structure of PLT 2, the side member includes a protruding portion that protrudes downward from a lower surface of the side member, and the battery unit is fixed to an inner surface of the protruding portion that faces the inner side in the vehicle width direction, and one end of the trailing arm is detachably coupled to a bottom surface of the protruding portion.

### CITATION LIST

### Patent Literature

PTL 1

Japanese Patent Application Laid-Open No. 2017-137003

PTL 2

Japanese Patent Application Laid-Open No. 2012-240586

### SUMMARY OF INVENTION

### Technical Problem

For satisfactory disposition space for a battery, an electric motor, and the like that are disposed on the frame, the frame structure is subject to restrictions on the shape, size, and disposition of the frame, which may lead to the difficulty to maintain the strength of the vehicle. In addition, it may be difficult to increase the supporting rigidity for supporting the battery.

An object of the present disclosure is to provide a battery support structure capable of increasing the supporting rigidity for a battery (herein also referred to as “battery supporting rigidity”).

### Solution to Problem

In order to achieve the above object, the battery support structure in the present disclosure is a battery support structure supporting a battery that supplies electric power to drive a motor, the battery being for driving. The battery support structure includes:
a pair of frames disposed to be separated from each other in a vehicle width direction of a vehicle;
a mounting table on which the battery is placed, the mounting table being attached on a frame of the pair of frames on an outer side in the vehicle width direction;
a first cross member mounted between the pair of frames at a predetermined position in the vehicle front-rear direction where the mounting table is attached; and
a second cross member disposed at a position higher than that of the first cross member and mounted between the pair of frames.

### Advantageous Effects of Invention

According to the present disclosure, it is possible to increase the battery supporting rigidity.

### BRIEF DESCRIPTION OF DRAWINGS

FIG. 1 is a plan view illustrating a frame structure of a vehicle in an embodiment of the present disclosure;

FIG. 2 is a side view illustrating the frame structure of the vehicle in the embodiment of the present disclosure;

FIG. 3 is a perspective view illustrating a battery support structure in the embodiment of the present disclosure;

FIG. 4 is a perspective view illustrating the battery support structure according to the embodiment of the present disclosure;

FIG. 5 is a plan view illustrating the battery support structure in the embodiment of the present disclosure;

FIG. 6 is a plan view illustrating the battery support structure when a frame is seen through in the embodiment of the present disclosure;

FIG. 7 is a plan view illustrating support structures for a pair of batteries in the embodiment of the present disclosure;

FIG. 8 is a plan view illustrating the support structures for a pair of batteries when frames are seen through in the embodiment of the present disclosure;

FIG. 9 is a plan view illustrating a restraint member and the like in the embodiment of the present disclosure;

FIG. 10 is a plan view illustrating the restraint member or the like when the frame is seen through in an embodiment of the present disclosure;

FIG. 11 is a perspective view illustrating the restraint member and the like in the embodiment of the present disclosure;

FIG. 12 illustrates the relationship between the position of a latch and the position of a lock pin;

FIG. 13 illustrates the relationship between the position of an output rod and the position of a link;

FIG. 14 is a plan view illustrating the battery support structure in the embodiment of the present disclosure;

FIG. 15 is a plan view illustrating an elastic member and the like in the embodiment of the present disclosure;

FIG. 16 is a side view illustrating the battery support structure in the embodiment of the present disclosure;

FIG. 17 is a plan view illustrating the battery support structure when the frame is seen through in the embodiment of the present disclosure; and

FIG. 18 is a front view of the battery support structure in the embodiment of the present disclosure as viewed from a front side of a vehicle;

### DESCRIPTION OF EMBODIMENTS

Hereinafter, an embodiment of the present disclosure will be described with reference to the drawings. A vehicle in the embodiment of the present disclosure is a commercial electric vehicle used for purposes such as cargo delivery, and includes a frame structure, a motor for traveling, and a battery for driving (also simply referred to as “driving battery”). However, the present disclosure is not limited to application in commercial electric vehicles and may also be applied to general electric vehicles. The driving battery is a battery for supplying electric power to a motor for traveling. The battery support structure in the embodiment of the present disclosure is a support structure that supports the battery on the frame structure side.

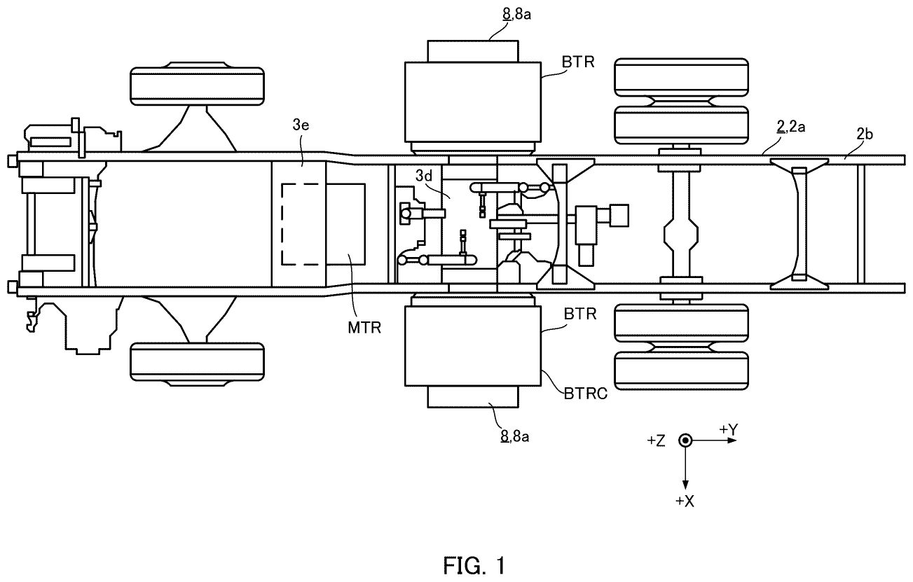

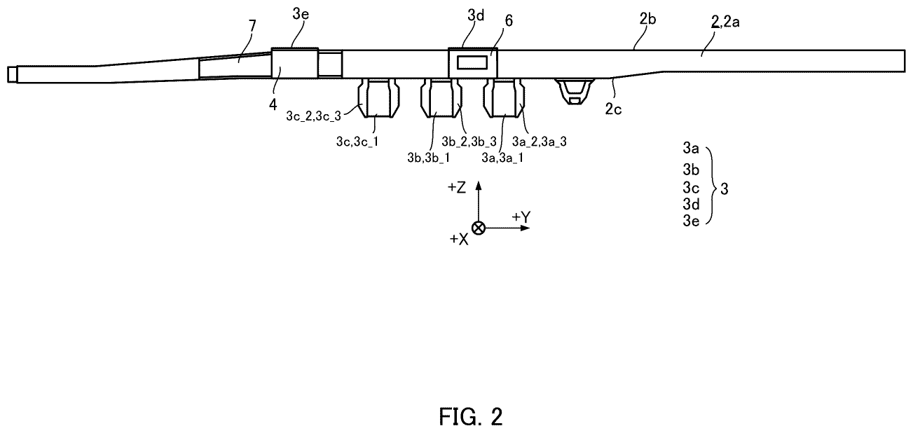

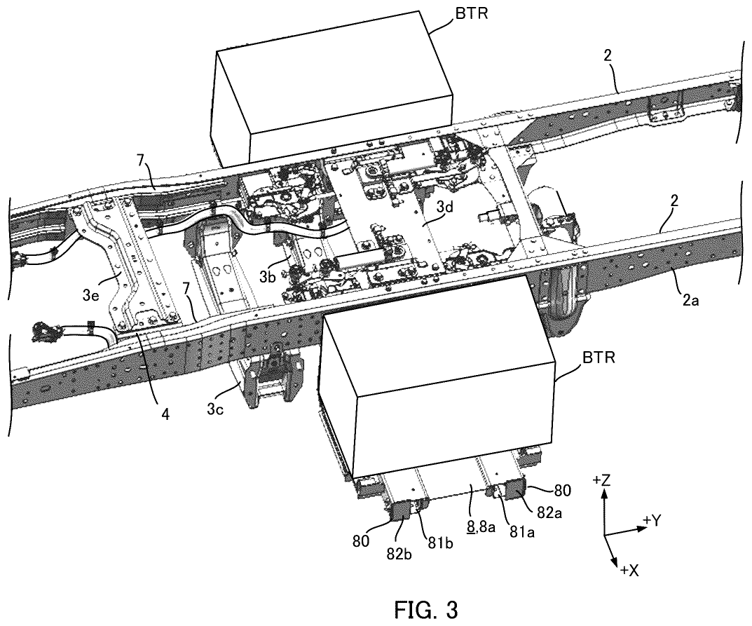

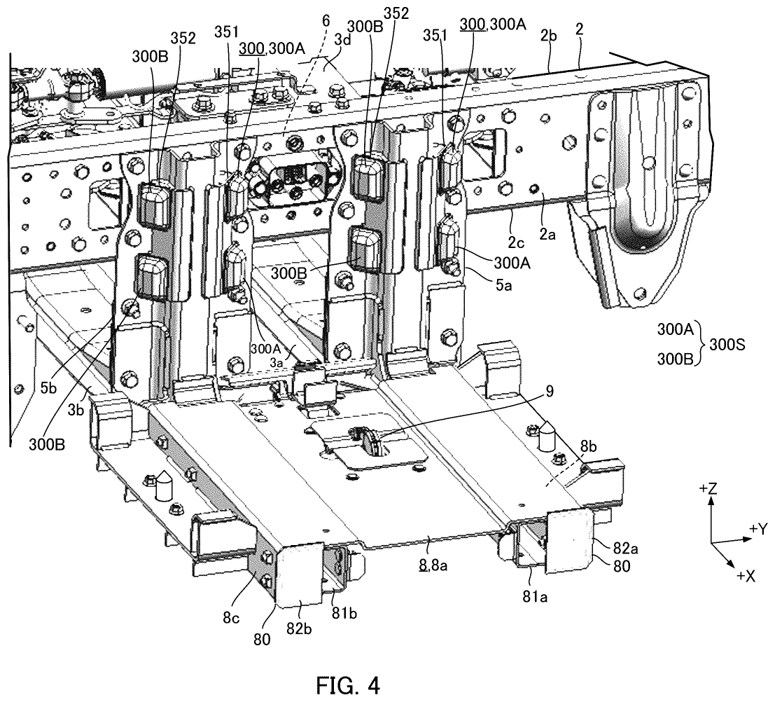

FIG. 1 is a plan view illustrating a frame structure of a vehicle in an embodiment of the present disclosure. FIG. 2 is a side view illustrating the frame structure of the vehicle in the embodiment of the present disclosure. FIG. 3 is a perspective view illustrating a battery support structure according to the embodiment of the present disclosure. FIG. 4 is a perspective view illustrating the battery support structure in the embodiment of the present disclosure. FIG. 1 illustrates an X axis, a Y axis, and a Z axis. The up-down direction in FIG. 1 is referred to as the vehicle width direction or an X direction, the direction away in the vehicle width direction from the center (in the vehicle width direction) side is referred to as the vehicle width direction outer side (i.e., outer side in the vehicle width direction) or the “+X direction,” and the direction approaching in the vehicle width direction to the center (in the vehicle width direction) side is referred to as the vehicle width direction inner side (i.e., inner side in the vehicle width direction) or the “−X direction.” The left-right direction in FIG. 1 is referred to as the vehicle front-rear direction or the Y direction, the right direction is referred to as the vehicle rear side, the vehicle rear direction, or the “+Y direction,” and the left direction is referred to as the vehicle front side, the vehicle front direction, or the “−Y direction.” The depth direction in FIG. 1 is referred to as the vehicle height direction, the up-down direction, or the Z direction, a direction in the drawing toward a viewer is referred to as the upward direction, the upper side, or the “+Z direction,” and a direction in the drawing away from the viewer is referred to as the downward direction, the lower side, or the “−Z direction.”

### Frame Structure

As illustrated in FIGS. 1, 2, 3, and 4, the frame structure includes a pair of frames 2 (side members), cross members 3a, 3b, 3c, 3d, and 3e, brackets 4, brackets 5a, brackets 5b, brackets 6, and closing frames 7. Brackets 4 are disposed at the same position in the vehicle front-rear direction (Y direction) in the pair of frames 2, respectively. In other words, brackets 4 are disposed at positions symmetrical to each other in the vehicle width direction (X direction) of the pair of frames 2, respectively. Similarly to brackets 4, brackets 5a, brackets 5b, brackets 6, and closing frames 7 are disposed at positions symmetrical to each other in the vehicle width direction (X direction) of the pair of frames 2, respectively.

Bracket 4 is a flat plate-shaped bracket having a substantially rectangular outer shape. Bracket 4 is disposed with the flat plate surface thereof facing the vehicle width direction (X direction). Bracket 4 is used when fastening frame 2 and closing frame 7.

Bracket 5a is a flat plate-shaped bracket having a substantially rectangular outer shape. Bracket 5a is disposed with the flat plate surface thereof facing the vehicle width direction (X direction). An upper portion of bracket 5a is fastened to groove wall 2a (see FIG. 3) having a substantially U-shaped cross section in frame 2. The lower portion of bracket 5a is fastened to cross member 3a and to mounting table 8 (see FIG. 3). Mounting table 8 is a table for mounting battery BTR (see FIG. 3). That is, cross member 3a and bracket 5a are disposed at a predetermined position in the vehicle front-rear direction where battery BTR is disposed. As illustrated in FIGS. 1 and 3, two batteries BTR are attached on vehicle 1. One of the batteries BTR is attached on one of the pair of frames from the outer side in the vehicle width direction. On the other hand, the other one of the batteries BTR is attached on the other one of the pair of frames from the outer side in the vehicle width direction.

Bracket 5b is disposed on the vehicle front side (−Y direction) compared to bracket 5a. Bracket 5b is a flat plate-shaped bracket having a substantially rectangular outer shape, similar to bracket 5a. Bracket 5b is disposed in the same manner as bracket 5a, with the flat plate surface thereof facing the vehicle width direction (X direction). An upper portion of bracket 5b is fastened to groove wall 2a of frame 2 (see FIG. 3). The lower portion of bracket 5b is fastened to cross member 3b and to mounting table 8 (see FIG. 3). That is, cross member 3b and bracket 5b are disposed at a predetermined position in the vehicle front-rear direction in the same manner as cross member 3a and bracket 5a, where battery BTR is disposed.

Bracket 6 (see FIG. 2) is a flat plate-shaped bracket having a predetermined outer shape. Bracket 6 is disposed with the flat plate surface thereof facing in the up-down direction (Z direction). An end portion of bracket 6 on the vehicle width direction outer side (+X direction) is fastened to groove wall 2b of frame 2 (see FIG. 4). An end portion of bracket 6 on the vehicle width direction inner side (−X direction) is fastened to cross member 3d. The position in the vehicle front-rear direction at which bracket 6 is disposed is a central position between the position in the vehicle front-rear direction at which bracket 5a is disposed and the position in the vehicle front-rear direction at which bracket 5b is disposed. That is, similar to cross member 3a, bracket 5a, cross member 3b, and bracket 5b, bracket 6 and cross member 3d are disposed at a predetermined position in the vehicle front-rear direction at which battery BTR is disposed.

The pair of frames 2 each extend in the vehicle front-rear direction and are disposed to be separated from each other in the vehicle width direction. Frame 2 is formed in a groove shape having a U-shaped cross section with the opening of the frame facing the vehicle width direction inner side (−X direction), and includes groove wall 2a that extends in the up-down direction (Z direction), groove wall 2b that is bent at the upper end of groove wall 2a and extends in the −X direction, and groove wall 2c that is bent at the lower end of groove wall 2a and extends in the −X direction. That is, the pair of frames 2 is disposed so that the openings thereof having a groove shape face each other in the vehicle width direction (X direction).

Cross members 3a, 3b, 3c, 3d, and 3e are disposed at a predetermined interval from each other and are mounted between the pair of frames 2. Cross members 3a, 3b, 3c, 3d, and 3e are collectively referred to as cross member 3 (see FIG. 2).

The frame structure in the present embodiment further includes closing frames 7. Closing frame 7 is provided in the opening of frame 2 and forms a cross-sectional shape closed by frame 2 and closing frame 7. As a result, it is possible to reinforce the frame structure. In the following description, a closed cross-sectional shape formed by frame 2 and the closing frame is referred to as a “closed cross-sectional shape.”

The frame structure in the present embodiment is subject to various restrictions for satisfactory disposition space for battery BTR, electric motor MTR, and the like to be disposed in frame 2. For example, the vehicle rear side end portion of closing frame 7 is shortened. Such a configuration reduces the strength of the frame structure. Therefore, in the embodiment of the present disclosure, as illustrated in FIG. 3, the vehicle rear side end portion of closing frame 7 is fastened to frame 2 with bracket 4 and a fastener (bolt, nut). Further, cross member 3e is mounted between the pair of frames 2 at a position in the vehicle front-rear direction where the vehicle rear end portion of closing frame 7 and frame 2 is fastened. As a result, it is possible to reinforce the frame structure.

Cross member 3a is formed to have a U-shaped cross-sectional shape with the opening thereof facing upward (+Z direction), and includes bottom wall 3a_1 that extends in the vehicle width direction (X direction), one side wall 3a_2 that is bent at one end of bottom wall 3a_1 on the vehicle width direction outer side and extends upward, and the other side wall 3a_3 that is bent at the other end of bottom wall 3a_1 on the vehicle width direction outer side and extends upward. The outer surface of one side wall 3a_2 in the vehicle width direction is fastened to the lower portion of bracket 5a with a fastener (bolt, nut). The outer surface of other side wall 3a_3 in the vehicle width direction is fastened to the lower portion of bracket 5a with a fastener (bolt, nut). As a result, cross member 3a is mounted between the pair of frames 2 via bracket 5a. Cross member 3a corresponds to the “first cross member” of the present disclosure.

Cross member 3b is disposed at a predetermined distance away from cross member 3a on the vehicle front side (−Y direction). Cross member 3b is formed to have the same cross-sectional shape as cross member 3a, and includes bottom wall 3b_1 that extends in the vehicle width direction (X direction), one side wall 3b_2 that is bent at one end of bottom wall 3b_1 on the vehicle width direction outer side and extends upward, and the other side wall 3b_3 that is bent at the other end of bottom wall 3b_1 on the vehicle width direction outer side and extends upward. The outer surface of one side wall 3b_2 in the vehicle width direction is fastened to the lower portion of bracket 5b with a fastener (bolt, nut). The outer surface of other side wall 3b_3 in the vehicle width direction is fastened to the lower portion of bracket 5b with a fastener (bolt, nut). As a result, cross member 3b is mounted between the pair of frames 2 via bracket 5b. Cross member 3b corresponds to the “first cross member” of the present disclosure.

Cross member 3d is disposed at a position in the upward direction (+Z direction) from a central position between a position in the vehicle front-rear direction (Y direction) at which cross member 3a is disposed and a position in the vehicle front-rear direction at which cross member 3b is disposed. Cross member 3d is a flat plate-shaped member having a substantially rectangular outer shape with the vehicle width direction (X direction) as its longitudinal direction. The outer end portion of cross member 3d in the vehicle width direction is fastened to the end portion of bracket 6 on the inner side in the vehicle width direction (−X direction) with a fastener (bolt, nut). Cross member 3d corresponds to the “second cross member” of the present disclosure.

As described above, cross member 3a, cross member 3b, bracket 5a, and bracket 5b are disposed at predetermined positions in the vehicle front-rear direction. Further, bracket 6 and cross member 3d are disposed at a predetermined position in the vehicle front-rear direction. As a result, double closed cross-sectional shapes are formed at predetermined positions in the vehicle front-rear direction. The first closed cross-sectional shape is formed by the pair of frames 2, cross member 3a, cross member 3d, bracket 5a, bracket 5b, and bracket 6. The second closed cross-sectional shape is formed by the pair of frames 2, cross member 3b, cross member 3d, bracket 5a, bracket 5b, and bracket 6.

As a result, at a predetermined position in the vehicle front-rear direction where battery BTR is disposed, for example, when a moment load around an axis extending in the vehicle front-rear direction (Y direction) acts on the pair of frames 2, a force in the opposite direction to the moment load is generated in cross member 3a and the like, which are components forming a closed cross-sectional shape, thereby reducing the deformation of frame 2. As a result, it is possible to increase the strength of the frame structure at a predetermined position in the vehicle front-rear direction. As a result, it is possible to prevent the supporting rigidity of the battery from decreasing.

Cross member 3c (see FIG. 2) is disposed at a predetermined distance away from the predetermined position in the vehicle front-rear direction toward the vehicle front side (−Y direction). Cross member 3c is formed in the same cross-sectional shape as cross member 3a, and includes bottom wall 3c_1, one side wall 3c_2, and the other side wall 3c_3. As a result, cross member 3c is mounted between the pair of frames 2.

Motor MTR (see FIG. 1) is disposed on cross member 3c. Motor MTR is disposed to be placed on bottom wall 3c_1. Cross member 3c corresponds to the “third cross member” of the present disclosure.

### Mounting Table 8, Slide Mechanism 80, and the Like

Next, mounting table 8, slide mechanism 80, and the like will be described with reference to FIGS. 3 and 4. Mounting table 8 is attached on frame 2 at a position on the vehicle width direction outer side (+X direction) via slide mechanism 80. As described above, two batteries BTR are attached on vehicle 1. Mounting table 8 and slide mechanism 80 and the like are also disposed corresponding to each of the two batteries BTR. In the following description, battery BTR, which is attached on frame 2 shown on the lower side in FIG. 3 from the vehicle width direction outer side, and mounting table 8 and slide mechanism 80, which are disposed corresponding to this battery BTR, will be mainly described.

Mounting table 8 is formed in a substantially inverted U-shaped cross-sectional shape, and includes top plate 8a that has a substantially rectangular plate surface facing upward (+Z direction), flange 8b that is bent at the vehicle rear side end of top plate 8a and extends downward (−Z direction), and flange 8c that is bent at the vehicle front side end of top plate 8a and extends downward (−Z direction). Battery BTR is placed on top plate 8a. Battery BTR includes a plurality of modules and the like and a box-shaped battery case BTRC housing the modules and the like. A striker (not illustrated) is provided at the bottom of battery case BTRC. WL latch 9 is disposed at the central portion of top plate 8a. WL latch 9 is capable of engaging with the striker to restrict the movement of battery BTR, which is placed on top plate 8a, in the upward direction (+Z direction), and is capable of disengaging from the striker to release the movement restriction of battery BTR in the upward direction (+Z direction).

Slide mechanism 80 includes guide rail 81a, guide rail 81b, slider 82a, and slider 82b. Guide rail 81a extends in the vehicle width direction (X direction). The end portion of guide rail 81a on the vehicle width direction inner side (−X direction) includes a flange that is bent and extends in the upward direction, and the flange is fastened to frame 2 via bracket 5a. Guide rail 81b is disposed on the vehicle front side (−Y direction) compared to guide rail 81a, and extends in the vehicle width direction (X direction). The end portion of guide rail 81b on the vehicle width direction inner side (−X direction) is bent and includes a flange that extends upward, and the flange is fastened to frame 2 via bracket 5b.

Slider 82a is disposed to be guidable in the vehicle width direction (X direction) by guide rail 81a. Flange 8b is fastened to slider 82a. Slider 82b is disposed to be guidable in the X direction by guide rail 81b. Flange 8c is fastened to slider 82b. As a result, battery BTR, which is placed on top plate 8a and whose movement in the upward direction (+Z direction) is restricted by WL latch 9, is integrated with slider 82a and slider 82b, and is guided in the vehicle width direction (X direction) by guide rail 81a and guide rail 81b.

### Restraint Member 10

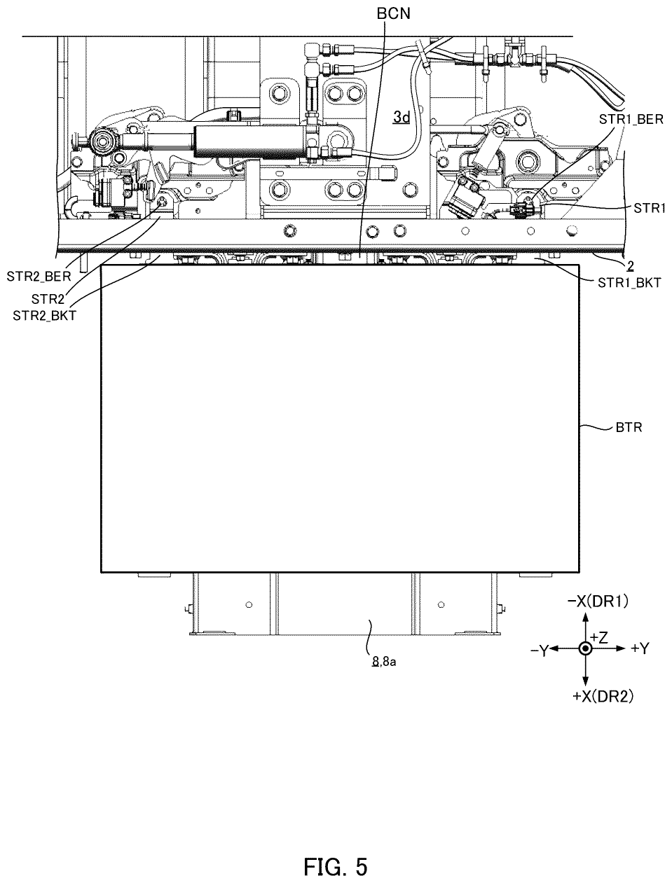

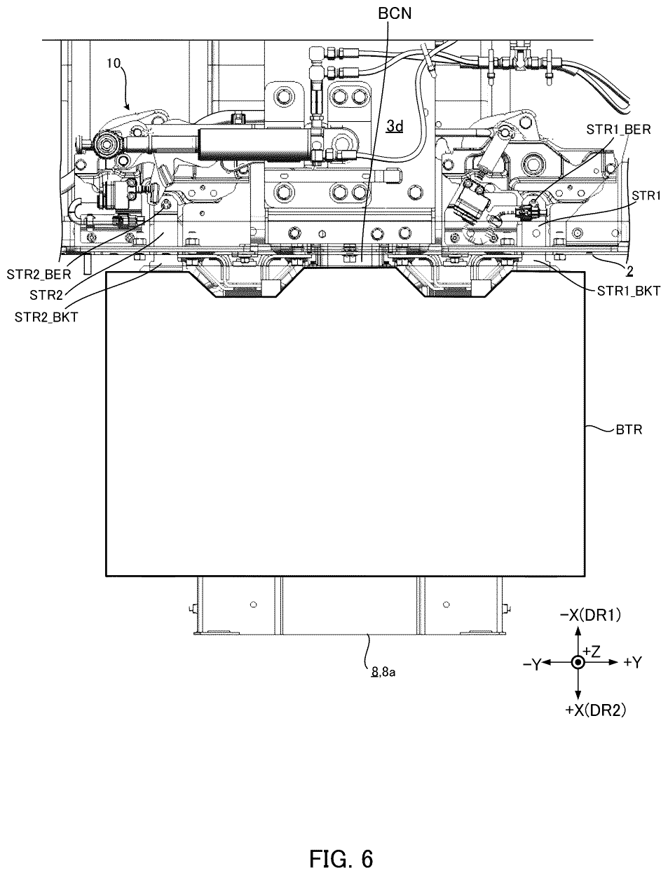

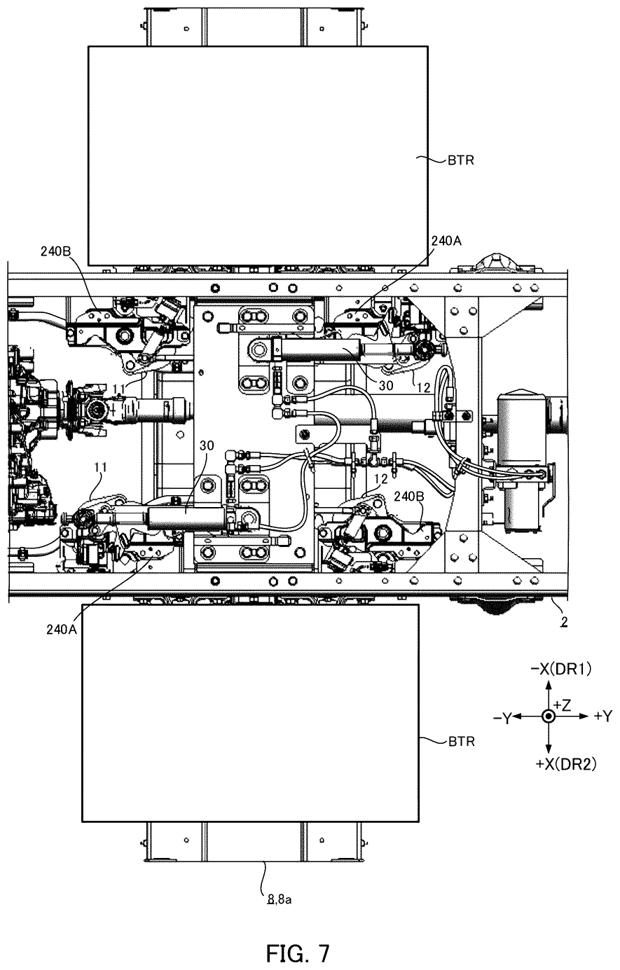

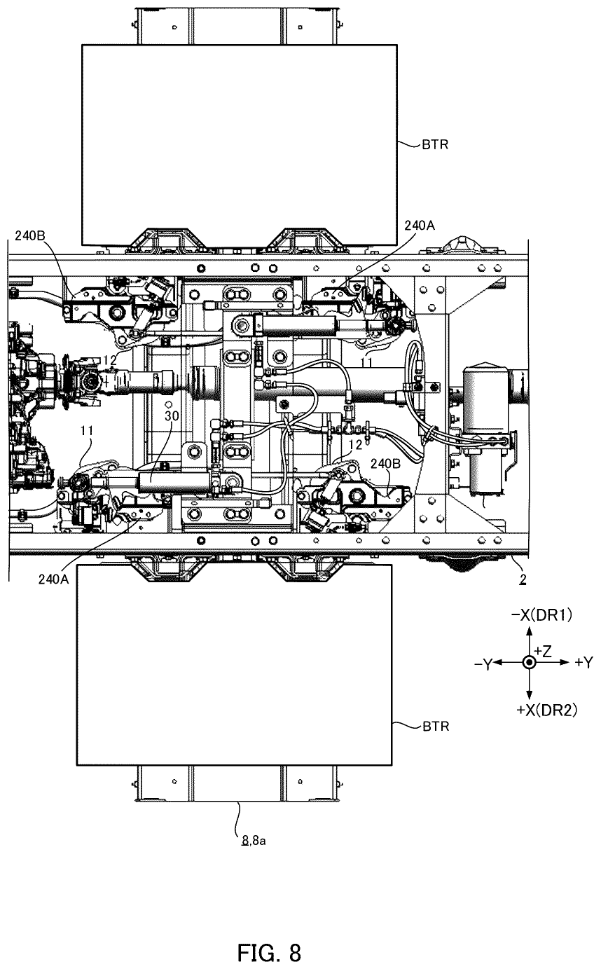

Next, restraint member 10, link mechanism 200, and the like will be described with reference to FIGS. 5, 6, 7, and 8. FIG. 5 is a plan view illustrating the battery support structure in the embodiment of the present disclosure. FIG. 6 is a plan view illustrating the battery support structure when the frame is seen through in the embodiment of the present disclosure. FIG. 7 is a plan view illustrating support structures for a pair of batteries in the embodiment of the present disclosure. FIG. 8 is a plan view illustrating the support structures for a pair of batteries when the frames are seen through in the embodiment of the present disclosure.

The pull-in (i.e., drawing) direction of battery BTR in the present disclosure is one direction DR1 along the horizontal plane. The pull-in direction of battery BTR in the present embodiment will be described as the vehicle width direction inner side (−X direction). One direction DR1 is not limited to this, and is set according to the disposition position of battery BTR. For example, when the position at which battery BTR is attached is a vehicle rear frame, the one direction DR1 may be a direction from the vehicle rear side to the vehicle front side.

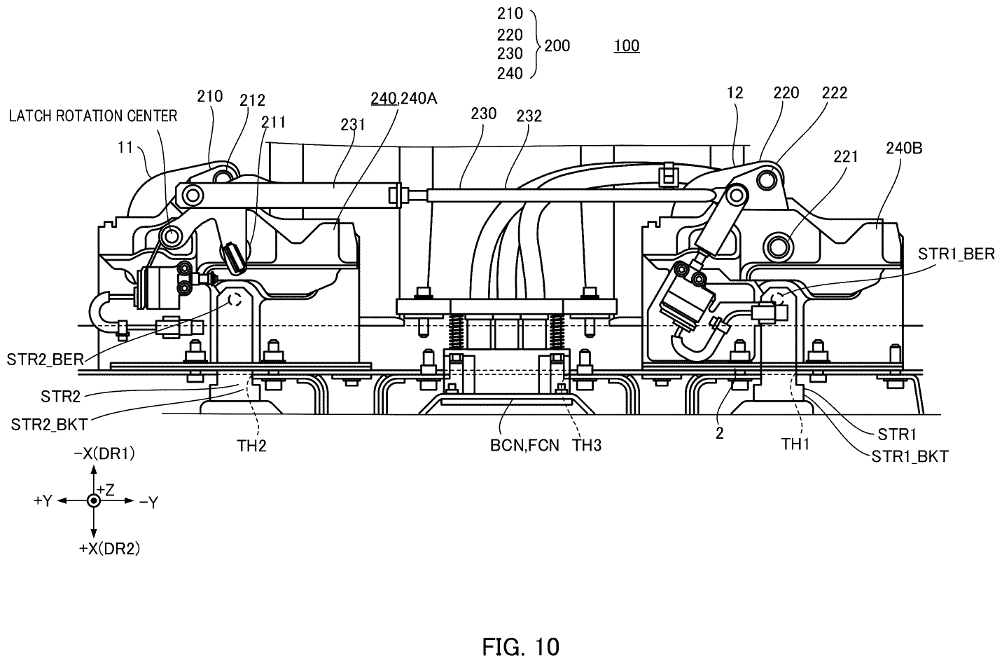

Battery BTR in the present embodiment is placed on top plate 8a with the side wall of the battery facing the vehicle width direction inner side (−X direction). Battery BTR is restrained in a state where battery BTR is drawn to frame 2 side. First striker STR1 is disposed on the side wall of battery BTR (the side wall drawn to restraint member 10). First striker STR1 includes the following: bracket STR1_BKT formed in a U-shaped cross-sectional shape and including an upper wall, a standing wall, and a lower wall; and striker bar STR1_BER formed in a rod shape and mounted between the upper wall and the lower wall. The standing wall of bracket STR1_BKT is fixed to the side wall of battery BTR so that the direction in which striker bar STR1_BER extends is directed in the up-down direction (Z direction). Frame 2 is provided with opened through-hole TH1 (see FIG. 10) through which first striker STR1 (the upper wall, the lower wall, and striker bar STR1_BER of bracket STR1_BKT) passes from the vehicle width direction outer side (+X direction) to the vehicle width direction inner side (−X direction) when battery BTR is drawn to the frame 2 side.

Second striker STR2 is disposed on the side wall of battery BTR at a predetermined distance from first striker STR1 in the vehicle front direction (−Y direction). Second striker STR2 includes bracket STR2_BKT having the same shape as bracket STR1_BKT and striker bar STR2_BER having the same shape as striker bar STR1_BER. Bracket STR2_BKT is fixed to the side wall of battery BTR so that the direction in which striker bar STR2_BER extends is directed in the up-down direction (Z direction). Frame 2 is provided with opened through-hole TH2 (see FIG. 10) through which second striker STR2 (the upper wall, the lower wall, and striker bar STR2_BER of bracket STR2_BKT) passes from the vehicle width direction outer side (+X direction) to the vehicle width direction inner side (−X direction) when battery BTR is drawn to the frame 2 side.

Battery connector BCN is disposed at a central position between the disposition position of first striker STR1 and the disposition position of second striker STR2 on the side wall of battery BTR. In a state where battery BTR is drawn to frame 2 and is restrained, battery connector BCN is electrically connected to vehicle-side connector FCN disposed on the frame 2 side. Further, frame 2 is provided with opened through-hole TH3 (see FIG. 10) through which battery connector BCN passes from the vehicle width direction outer side (+X direction) to the vehicle width direction inner side (−X direction) when battery BTR is drawn to frame 2 side.

Restraint member 10 is disposed on frame 2 side. Restraint member 10 restrains battery BTR in a state where battery BTR is drawn to the frame 2 side in such a way that, when battery BTR is drawn to the frame side (inner side in the vehicle width direction, −X direction, one direction DR1) with a predetermined force, battery BTR receives a reaction force against the predetermined force. Restraint member 10 includes first latch 11 and second latch 12. First latch 11 is configured to be capable of engaging with and disengaging from first striker STR1. In detail, first latch 11 is configured to be engageable with/detachable from striker bar STR1_BER of first striker STR1. Second latch 12 is configured to be engageable with/detachable from second striker STR2. Specifically, second latch 12 is configured to be engageable with/detachable from striker bar STR2_BER of second striker STR2. In the following description, first latch 11 being engaged with/detached from striker bar STR1_BER will be referred to as first latch 11 being engaged with/detached from first striker STR1. Similarly, second latch 12 being engaged with/detached from striker bar STR2_BER is referred to as second latch 12 being engaged with/detached from second striker STR2.

First latch 11 turns between an unlock position at which first latch 11 is detached from first striker STR1 and a lock position at which first latch 11 is engaged with first striker STR1, and further, is turnable between the lock position and a drawing position at which battery BTR is drawn toward vehicle 1 side via first striker STR1.

Second latch 12 turns between an unlock position at which second latch 12 is detached from second striker STR2 and a lock position at which second latch 12 is engaged with second striker STR2, and further, is turnable between the lock position and a drawing position at which battery BTR is drawn toward vehicle 1 side via second striker STR2.

### Link Mechanism 200

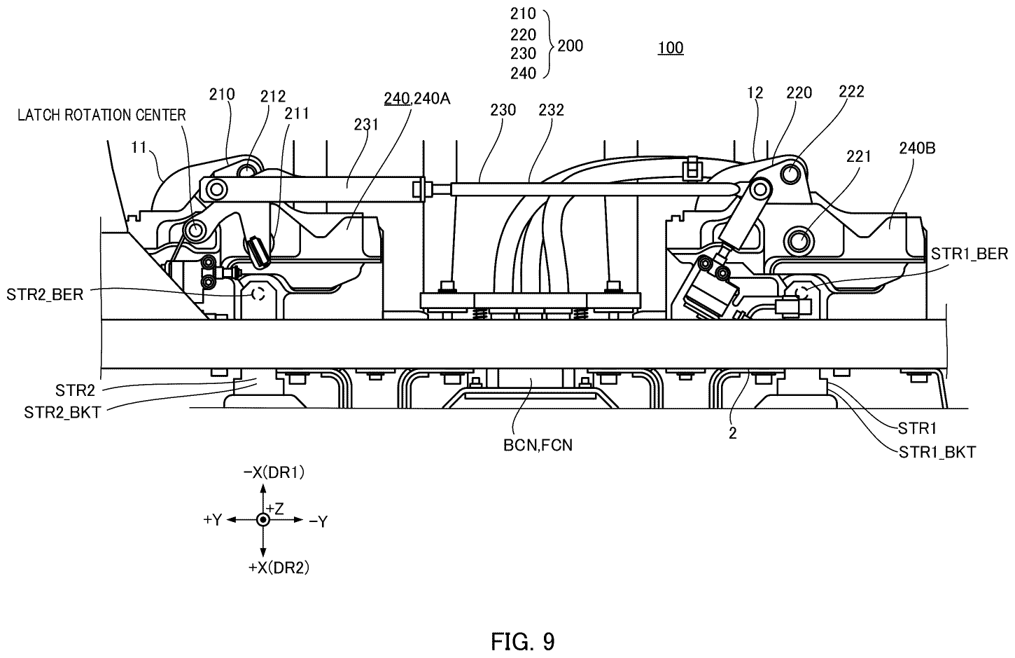

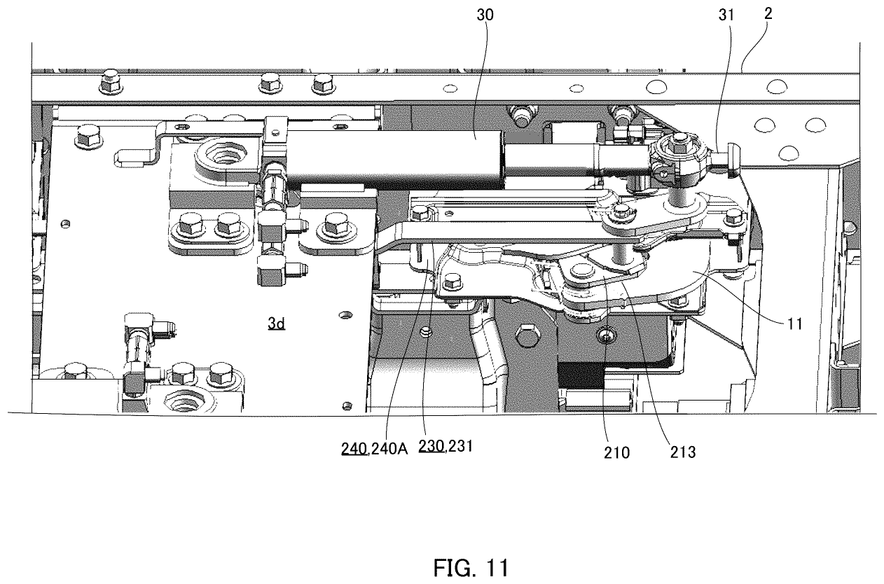

FIG. 9 is a plan view illustrating the restraint member and the like in the embodiment of the present disclosure. FIG. 10 is a plan view illustrating the restraint member and the like when the frame is seen through in the embodiment of the present disclosure. FIG. 11 is a perspective view illustrating the restraint member and the like in the embodiment of the present disclosure. Link mechanism 200 includes first link 210, second link 220, intermediate link 230, and fixed link 240. Link mechanism 200 in the present embodiment is a parallel link mechanism. That is, the distance from one end portion 211 of first link 210 in the length direction of the link (herein also referred to as “one end portion in the length direction 211”) to the other end portion 212 of first link 210 in the length direction of the link (herein also referred to as “other end portion in the length direction 212”) is equal to the distance from one end portion 221 of second link 220 in the length direction (herein also referred to as “one end portion in the length direction 221”) to the other end portion 222 of second link 220 in the length direction (herein also referred to as “other end portion in the length direction 222”). Further, the length of intermediate link 230 is equal to the distance between the position of one end portion in the length direction 211 of first link 210 and the position of one end portion in the length direction 221 of second link 220.

In the present embodiment, fixed link 240 is divided into fixed link 240A and fixed link 240B. Fixed link 240A is disposed on frame 2 so as to correspond to first latch 11. Further, fixed link 240B is disposed on frame 2 so as to correspond to second latch 12.

First link 210 is constituted by two members. The two members are integrated with each other. First link 210 is turnably coupled to fixed link 240A at one end portion in the length direction 211, and is turnably coupled to first latch 11 at the other end portion in the length direction 212.

Second link 220 is constituted by two members. The two members are integrated with each other. Second link 220 is turnably coupled to fixed link 240B at one end portion in the length direction 221, and is turnably coupled to second latch 12 at the other end portion in the length direction 222.

Intermediate link 230 includes link bracket 231 and link bar 232, and link bracket 231 and link bar 232 are coupled to each other such that the length of the link is adjustable. Intermediate link 230 couples intermediate portion 213 (see FIG. 11) in first link 210 (the intermediate portion located between one end portion in the length direction 211 and the other end portion in the length direction 212) with intermediate portion 213 in second link 220 (the intermediate portion located between one end portion in the length direction 221 and the other end portion in the length direction 222). The coupling position of intermediate link 230 is not limited to this, and for example, intermediate link 230 may couple other end portion in the length direction 212 of first link 210 with other end portion in the length direction 222 of second link 220.

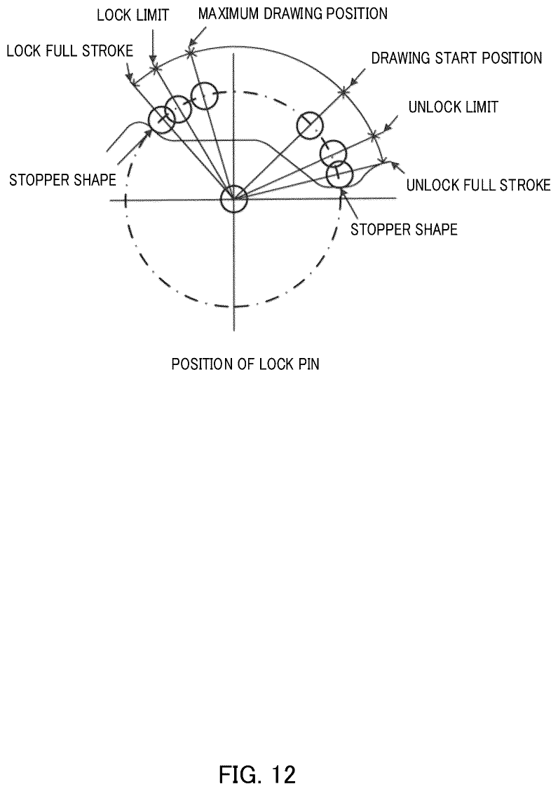

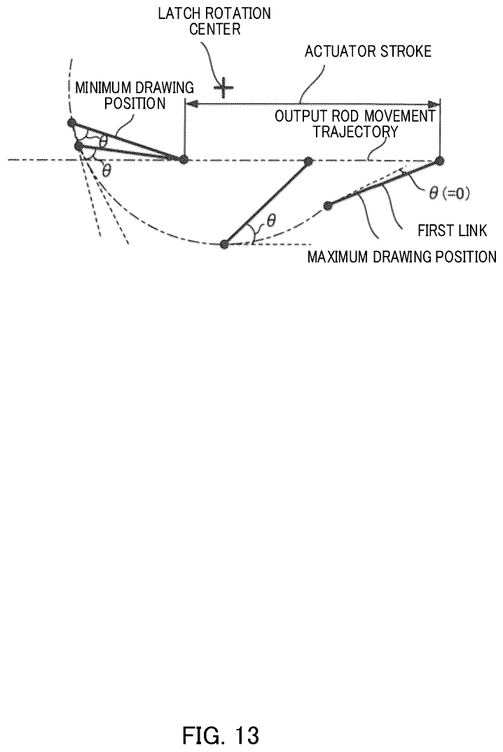

Next, the operations of first latch 11, second latch 12, and link mechanism 200 will be described with reference to FIGS. 12 and 13. In the following description, first latch 11 and second latch 12 are collectively referred to as “latches.” Further, first link 210 and second link 220 are collectively referred to as “links.”

### Actuator 30

Battery support structure 100 in the present embodiment includes a single actuator 30 that operates each of first latch 11 and second latch 12 via link mechanism 200. Actuator 30 includes output rod 31 (see FIG. 11). Actuator 30 in the present embodiment is a hydraulic cylinder. In the present embodiment, a part of the hydraulic circuit for driving actuator 30 is omitted. A link (not illustrated) that moves in conjunction with output rod 31 is turnably provided in fixed link 240, and lock pin PIN is fixed to the link. The movement of lock pin PIN is restricted/released by the stopper shape, thereby restricting the stroke of output rod 31.

Output rod 31 is coupled to first link 210. Output rod 31 may be coupled to second link 220. Output rod 31 is movable backward and forward along the direction in which intermediate link 230 extends. Further, output rod 31 is movable backward and forward in a direction orthogonal to the drawing direction in which battery BTR is drawn to vehicle 1.

FIG. 12 illustrates the relationship between the position of the latch and the position of the lock pin. In FIG. 12, lock pin PIN is illustrated with a one-dot chain line, and the stopper shape for restricting/releasing the movement of lock pin PIN is illustrated with a solid line. In FIG. 12, the drawing direction of battery BTR is indicated in a counterclockwise direction, and the pull-back direction of battery BTR is indicated in a clockwise direction. At the unlock full stroke, which is a position where the latch is turned by a predetermined angle clockwise from the unlock limit, lock pin PIN abuts against the stopper shape. As a result, the stroke of output rod 31 is limited. The drawing start position is set at a position where the latch is turned by a predetermined angle in the counterclockwise direction from the unlock limit. The maximum drawing position is set at a position where the latch turns counterclockwise by a predetermined angle from the drawing start position. The lock limit is set at a position where the latch is movable by a predetermined angle in the counterclockwise direction from the maximum drawing position. In the lock full stroke, which is a position where the latch is turned by a predetermined angle counterclockwise from the lock limit, lock pin PIN abuts against the stopper shape. As a result, the stroke of output rod 31 is limited.

FIG. 13 illustrates the relationship between the position of the output rod and the position of the link. As described above, link mechanism 200 in the present embodiment is a parallel link mechanism, and first link 210 and second link 220 perform the same movement as each other. FIG. 13 illustrates first link 210 as a representative link in link mechanism 200 in solid lines, and also illustrates one end portion in the length direction 211 and the other end portion in the length direction 212 of first link 210 in solid black circles. In FIG. 13, an arc, which is a trajectory of a position of other end portion in the length direction 212 of first link 210, is illustrated with a one-dot chain line, a tangent line at each position of the other end portion in the arc is illustrated with a broken line, and an angle θ of first link 210 in the length direction with respect to the direction of the tangent line at each position of the other end portion is illustrated.

When first latch 11 turns between the unlock position and the lock position, the length direction of first link 210 forms an acute angle with a direction of a tangent line passing through a position of other end portion in the length direction 212 of first link 210 (the position on a circumference concentric with the turning center of first latch 11). That is, in a region between the unlock position and the lock position, angle θ of first link 210 in the length direction with respect to the direction of the tangent line changes within a range of an acute angle (0°<θ<90°). As a result, first link 210 can transmit from actuator 30 to first latch 11 the force in the direction necessary for first latch 11 to turn between the unlock position and the lock position, can reliably transmit the force to the first latch, and can allow the first latch to turn smoothly, thereby making it possible to avoid, for example, the occurrence of a deadlock.

Further, when second latch 12 turns between the unlock position and the lock position, the length direction of second link 220 forms an acute angle with a direction of a tangent line passing through a position of other end portion in the length direction 222 of second link 220 (the position on a circumference concentric with the turning center of second latch 12). That is, in the same manner as first latch 11, angle θ of first link 210 in the length direction with respect to the direction of the tangent line changes within the range of an acute angle (0°<θ<90°) between the unlock position and the lock position. As a result, second link 220 can transmit the force in the direction necessary to turn second latch 12 between the unlock position and the lock position from actuator 30 to second latch 12. Therefore, second latch 12 can turn smoothly in the same manner as first latch 11.

When first latch 11 turns to the drawing position (the maximum drawing position illustrated in FIG. 13), the length direction of first link 210 is substantially parallel to the direction of a tangent line passing through the position of other end portion in the length direction 212 of first link 210 on the circumference. In FIG. 13, the state in which the length direction of second link 220 and the direction of the tangent line are parallel to each other is indicated by “θ(=0).” Similarly, when second latch 12 turns to the drawing position (a position corresponding to the maximum drawing position illustrated in FIG. 13), the length direction of second link 220 is substantially parallel to the direction of a tangent line passing through the position of other end portion in the length direction 222 of second link 220 on the circumference. The allowable tolerance of the parallelism in the length direction with respect to the direction of the tangent line is set, for example, according to the driving force of actuator 30, the set axial force of a bolt that fixes each of first latch 11, second latch 12, and actuator 30, and the like.

As a result, first link 210 can efficiently transmit to first latch 11 the force for turning first latch 11, and second link 220 can efficiently transmit to second latch 12 the force for turning second latch 12, making it possible to efficiently operate each of first latch 11 and second latch 12 and to draw battery BTR toward vehicle 1 side with sufficient force.

With the above configuration, battery BTR is supported on frame 2 side in a state where battery BTR is drawn in one direction DR1 (vehicle width direction inner side) along the horizontal plane. As a result, even when vehicle vibration causes battery case BTRC to move with respect to frame 2, the frictional resistance between battery case BTRC and frame 2 is generated, and it is possible to suppress the rattling of battery BTR in the vehicle front-rear direction. It should be noted that, it may be difficult to prevent battery BTR from rattling in the vehicle front-rear direction only with the friction resistance between battery case BTRC and frame 2.

### Elastic Body 300, First Elastic Body 300A, Second Elastic Body 300B, Elastic Body Set 300S

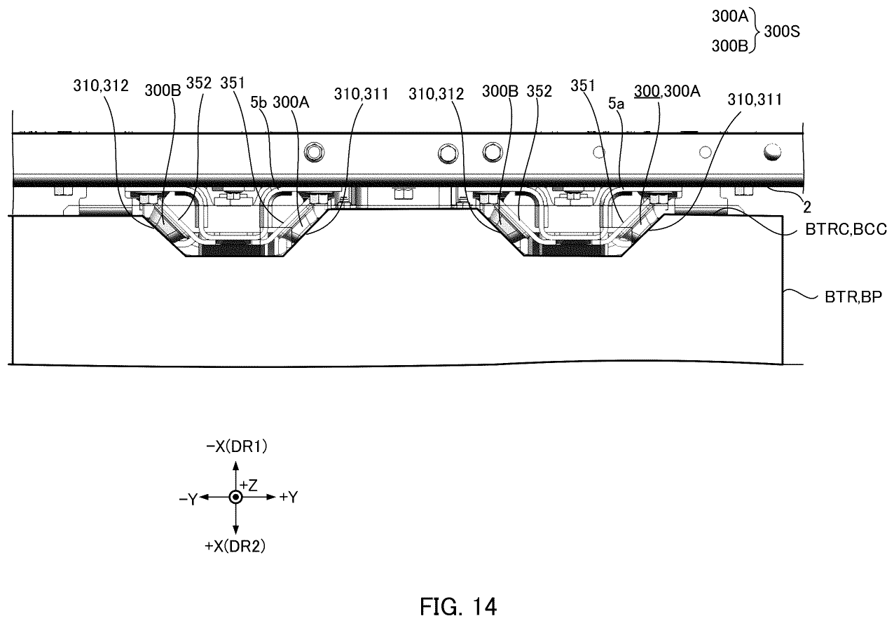

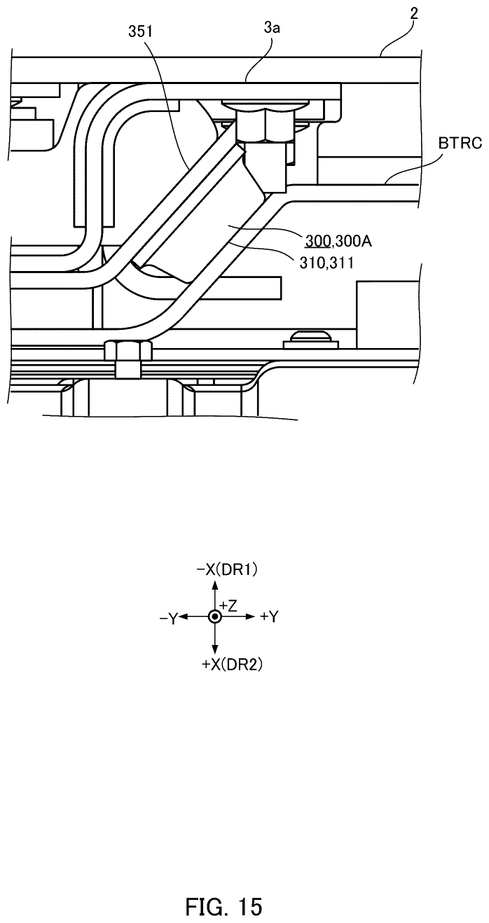

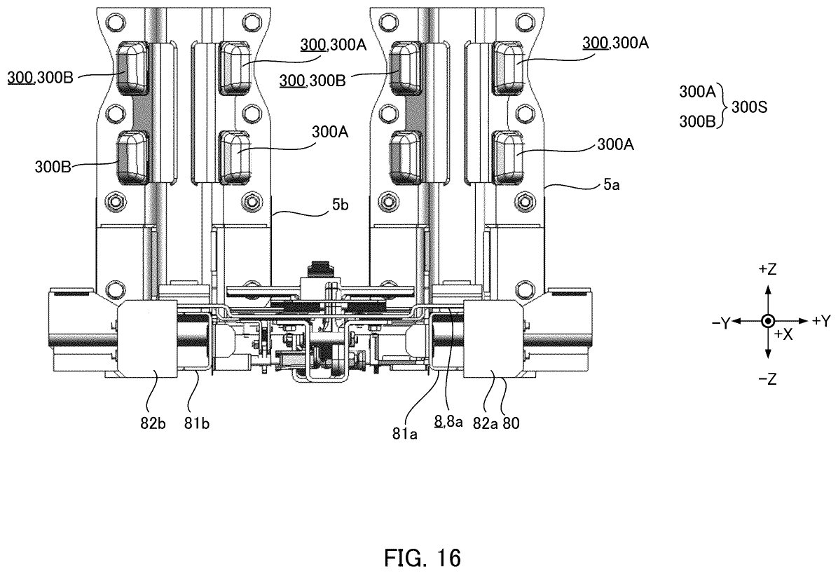

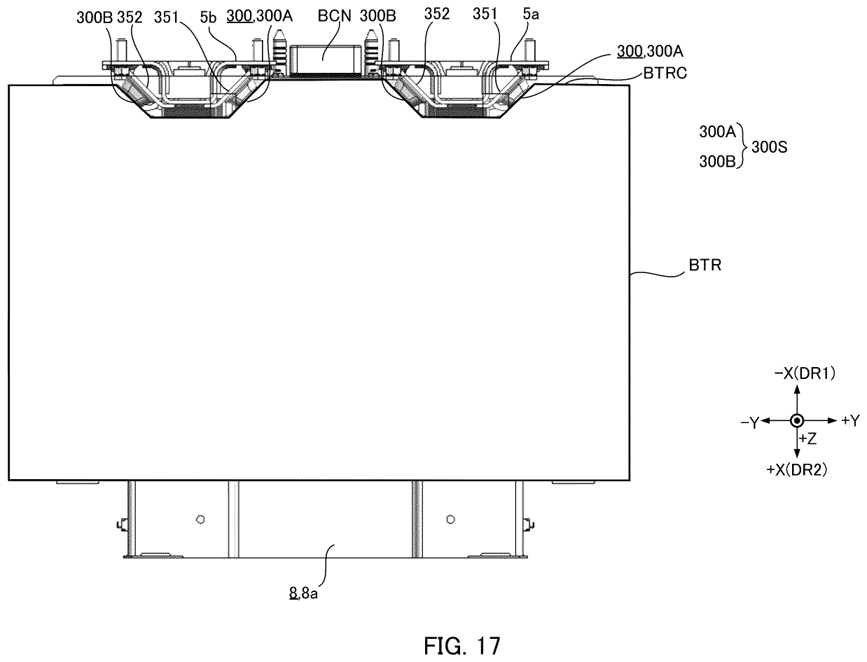

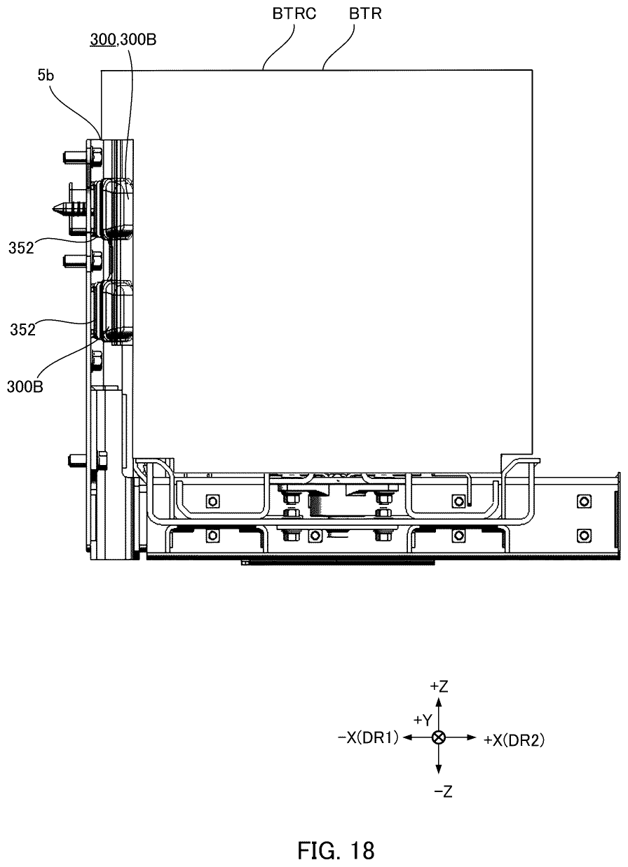

Next, elastic body 300 and the like will be described with reference to FIGS. 14 to 18. FIG. 14 is a plan view illustrating the battery support structure in an embodiment of the present disclosure. FIG. 15 is a plan view illustrating an elastic member and the like in the embodiment of the present disclosure. FIG. 16 is a side view illustrating the battery support structure in the embodiment of the present disclosure. FIG. 17 is a plan view illustrating the battery support structure when the frame is seen through in the embodiment of the present disclosure. FIG. 18 is a front view of the battery support structure in the embodiment of the present disclosure as seen from the front side of the vehicle.

Elastic body 300 is a plate-shaped elastic body including plate surface 310 (see FIGS. 14 and 15) constituted by a flat plate-shaped surface. Elastic body 300 is disposed at a position corresponding to each of bracket 5a and bracket 5b. Hereinafter, elastic body 300 disposed at bracket 5a will be representatively described, and elastic body 300 disposed at bracket 5b will be described mainly in terms of differences from elastic body 300 disposed at bracket 5a. Further, elastic body 300 disposed at first bracket 351 is used as first elastic body 300A. Alternatively, elastic body 300 disposed at second bracket 352 is used as second elastic body 300B. First bracket 351 and second bracket 352 are metal plates. Each of both end portions of the plate is welded to bracket 5a. In the present embodiment, first elastic body 300A and second elastic body 300B are used in combination with each other. Hereinafter, a combination of first elastic body 300A and second elastic body 300B may be referred to as an “elastic body set.” Two elastic body sets 300S are disposed at bracket 5a to be separated from each other in the up-down direction.

First elastic body 300A is disposed so that plate surface 310 becomes first elastic surface 311 (see FIGS. 14 and 15) that is inclined toward one side in the orthogonal direction (in the present embodiment, the vehicle rear side) along the horizontal plane with respect to other direction DR2 (the vehicle width direction outer side in FIG. 14) that is opposite to one direction DR1 (the vehicle width direction inner side in the present embodiment). Further, the inclination angle at which first elastic surface 311 is inclined toward the one side in the orthogonal direction with respect to other direction DR2 is set according to the weight, size, and the like of battery BTR. First elastic body 300A is disposed on the frame 2 side via first bracket 351 and bracket 5a so that plate surface 310 constitutes first elastic surface 311. Bracket 5a is formed such that the horizontal cross section thereof has a hat channel shape. The end portion of the bracket on the vehicle rear side (+Y direction) and an end portion of the bracket on the vehicle front side (−Y direction) are located on the vehicle width direction inner side (−X direction) compared to the central portion of the bracket in the vehicle front-rear direction (Y direction). Specifically, plate surface 310 constitutes first elastic surface 311 by being spanned between the end portion on the vehicle rear side and the central portion in the vehicle front-rear direction.

When battery BTR is drawn in one direction DR1, first elastic surface 311 is sandwiched between the battery case BTRC side and the frame 2 side (first bracket 351 side) thus compressed and deformed, and a restoring force against the compressed deformation is generated. As a result, one component in the direction in which first elastic surface 311 is restored becomes other direction DR2 (in the present embodiment, the vehicle width direction outer side). Further, another component in the direction in which first elastic surface 311 is restored becomes one side in the direction orthogonal to other direction DR2 (in the present embodiment, the vehicle rear side). On the other hand, battery case BTRC includes an inclined surface that is inclined along first elastic surface 311. As a result, battery case BTRC is pushed back in the other direction DR2 and is also pushed back toward the vehicle rear side by the restoring force of first elastic surface 311.

Second elastic surface 312 is disposed on the vehicle front side (−Y direction) compared to first elastic surface 311. In other words, first elastic surface 311 and second elastic surface 312 are disposed to be separated from each other in the vehicle front-rear direction (Y direction).

Second elastic body 300B is disposed so that plate surface 310 becomes second elastic surface 312 that is inclined toward the other side in the orthogonal direction (vehicle front side in the present embodiment) along the horizontal plane with respect to one direction DR1 and the other direction DR2 (vehicle width direction outer side). Further, the inclination angle at which second elastic surface 312 is inclined toward the other side in the orthogonal direction with respect to other direction DR2 is set according to the weight, size, and the like of battery BTR. Second elastic body 300B is disposed on the frame 2 side via second bracket 352 and bracket 5a so that plate surface 310 constitutes second elastic surface 312 (see FIG. 14). Specifically, plate surface 310 constitutes second elastic surface 312 by being spanned between the end portion of bracket 5 on the vehicle front side and the central portion in the vehicle front-rear direction.

When battery BTR is drawn in one direction DR1, Second elastic surface 312 is sandwiched between battery case BTRC side and frame 2 side (second bracket 352 side) and thus compressed and deformed, and a restoring force against the compressed deformation is generated. As a result, one component in the direction in which second elastic surface 312 is restored becomes other direction DR2 (vehicle width direction outer side). Further, another component in the direction in which second elastic surface 312 is restored becomes one side in the orthogonal direction (vehicle front side) along the horizontal plane with respect to other direction DR2. On the other hand, battery case BTRC includes an inclined surface that is inclined along second elastic surface 312. As a result, battery case BTRC is pushed back in the other direction DR2 and is also pushed back toward the vehicle front side by the restoring force of second elastic surface 312. The force with which battery case BTRC is pushed back toward the vehicle rear side by the restoring force of first elastic surface 311 is balanced with the force with which battery case BTRC is pushed back toward the vehicle front side by the restoring force of second elastic surface 312.

With the above configuration, in a case where battery BTR is supported on frame 2 side in a state of battery BTR being drawn in one direction DR1 (vehicle width direction inner side), even when vehicle vibration causes battery case BTRC to move in the vehicle width direction (X direction) with respect to frame 2, it is possible to suppress rattling of battery BTR in the vehicle width direction (X direction) from the following reasons: battery BTR is supported in a state in which the reaction force in other direction DR2 due to the restoring force of first elastic surface 311 and the drawing force in one direction DR1 are balanced, and battery BTR is supported in a state in which the reaction force in other direction DR2 due to the restoring force of second elastic surface 312 and the drawing force in one direction DR1 are balanced. Further, even when vehicle vibration causes battery case BTRC to move in the vehicle front-rear direction (Y direction) with respect to frame 2, it is possible to suppress rattling of battery BTR in the vehicle front-rear direction (Y direction) because battery BTR is supported in a state of being balanced in the vehicle front-rear direction (Y direction) by the respective restoring forces of first elastic surface 311 and second elastic surface 312.

Elastic body 300A disposed in first bracket 351 has been described. Elastic body 300B disposed in second bracket 352 is the same as elastic body 300A. That is, even when vehicle vibration causes battery case BTRC to move in the vehicle width direction (X direction) with respect to frame 2, it is possible to suppress rattling of battery BTR in the vehicle width direction (X direction) from the following reasons: battery BTR is supported in a state in which the reaction force in other direction DR2 due to the restoring force of first elastic surface 311 and the drawing force in one direction DR1 are balanced, and battery BTR is supported in a state in which the reaction force in other direction DR2 due to the restoring force of second elastic surface 312 and the drawing force in one direction DR1 are balanced. Further, even when vehicle vibration causes battery case BTRC to move in the vehicle front-rear direction (Y direction) with respect to frame 2, it is possible to suppress rattling of battery BTR in the vehicle front-rear direction (Y direction) because battery BTR is supported in a state of being balanced in the vehicle front-rear direction (Y direction) by the respective restoring forces of first elastic surface 311 and second elastic surface 312.

As described above, providing elastic body 300A and elastic body 300B can prevent battery BTR from rattling in the vehicle width direction (X direction). Further, it is possible to prevent battery BTR from rattling in the vehicle front-rear direction (Y direction). Further, as described above, battery BTR placed on top plate 8a is restricted from moving in the upward direction (+Z direction) by WL latch 9, and thus, it is possible to prevent battery BTR from rattling in the up-down direction (Z direction).

Further, elastic body set 300S in which elastic body 300A and elastic body 300B are combined with each other is also disposed at bracket 5b. Two elastic body sets 300S are disposed vertically spaced apart at bracket 5b. As a result, when battery BTR is drawn in one direction DR1 (frame 2 side), battery BTR unevenly receives a reaction force to the drawing force in the vehicle front-rear direction (Y direction), and thus, battery BTR does not receive, for example, a moment load around the vehicle front side end portion or a moment load around the vehicle rear side end portion, thereby stably attaching battery BTR on the frame 2 side. From this point, it is also possible to suppress rattling of battery BTR due to vehicle vibration.

Further, elastic body sets 300S are disposed at both end portions of the side wall of battery BTR in the vehicle front-rear direction, and battery connector BCN is disposed at the central position of the side wall of battery BTR in the vehicle front-rear direction. At the central position of the side wall of battery BTR in the vehicle front-rear direction, it is possible to sufficiently prevent battery BTR from rattling due to vehicle vibration. As a result, it is possible to maintain the electrical connection state with vehicle-side connector FCN.

Battery support structure 100 in the above embodiment supports battery BTR on the vehicle 1 side. The battery support structure includes restraint member 10 that restrains battery BTR in a state where battery BTR is drawn toward the vehicle 1 side in such a way that, when battery BTR is drawn toward the vehicle 1 side with a predetermined force, the battery receives a reaction force against the predetermined force.

Battery support structure 100 in the above embodiment supports driving battery BTR that supplies electric power to drive motor MTR. The battery support structure includes the following: a pair of frames 2 disposed to be separated from each other in the vehicle width direction of vehicle 1; mounting table 8 attached on frame 2 on the outer side in the vehicle width direction (+X direction), and battery BTR is placed on the mounting table; cross members 3a and 3b mounted between the pair of frames 2 at predetermined positions in the vehicle front-rear direction where mounting table 8 is attached, and cross member 3d disposed at a position higher than those of cross members 3a and 3b and mounted between the pair of frames 2.

With the above-described configuration, the pair of frames 2, cross members 3a and 3b, and cross member 3d form a closed cross-sectional shape at a predetermined position in the vehicle front-rear direction. In addition, mounting table 8 is attached at the predetermined position in the vehicle front-rear direction, and battery BTR is placed on the mounting base 8. In this case, a closed cross-sectional shape is formed at a predetermined position in the vehicle front-rear direction, and therefore, it is possible to increase the battery supporting rigidity compared to when the battery is supported on a typical ladder frame structure in which a cross member is mounted between a pair of frames 2.

Battery support structure 100 in the above embodiment further includes cross member 3c that is mounted between the pair of frames 2 at a position in the vehicle front direction compared to the predetermined position in the vehicle front-rear direction, and motor MTR is disposed on cross member 3c. Further providing cross members 3c mounted between the pair of frames 2 can further increase the rigidity of the frame structure of vehicle 1. Moreover, cross member 3c can be effectively utilized as a space for disposing motor MTR.

Battery support structure 100 for a battery in the above embodiment further includes restraint member 10 that restrains battery BTR on the vehicle 1 side, and restraint member 10 is disposed on frame 2. As a result, battery BTR can be supported on the frame 2 side via restraint member 10. Moreover, frame 2 can be effectively utilized as a space for disposing restraint member 10.

In battery support structure 100 in the above embodiment, restraint member 10 restrains battery BTR in a state where the battery is drawn toward the vehicle 1 side in such a way that, when battery BTR is drawn in one direction DR1 (toward the vehicle side) with a predetermined force, battery BTR receives a reaction force against the predetermined force. As a result, battery BTR is restrained in a state where battery BTR is drawn to the vehicle 1 side, and does not move relatively with respect to vehicle 1, and it is possible to suppress the rattling of battery BTR due to vehicle vibration.

Battery support structure 100 in the above embodiment further includes actuator 30 that transmits power to restraint member 10 for drawing battery BTR with a predetermined force, and actuator 30 is disposed on cross member 3d. As a result, cross member 3d can be effectively utilized as a space for disposing actuator 30.

Each of the above-described embodiment merely shows an example of specific implementation of the present disclosure, and the technical scope of the present disclosure should not be construed to be limited thereto. That is, the present disclosure can be implemented in a variety of ways without departing from the spirit or essential features thereof.

### INDUSTRIAL APPLICABILITY

The present disclosure is suitably utilized in a vehicle including a battery support structure that requires increased battery supporting rigidity.

1. A battery support structure supporting a battery that supplies electric power to drive a motor, the battery being for driving, the battery support structure comprising:
a pair of frames disposed to be separated from each other in a vehicle width direction of a vehicle;
a mounting table on which the battery is placed, the mounting table being attached on a frame of the pair of frames on an outer side in the vehicle width direction;
a first cross member mounted between the pair of frames at a predetermined position in the vehicle front-rear direction where the mounting table is attached; and
a second cross member disposed at a position higher than that of the first cross member and mounted between the pair of frames.

2. The battery support structure according to claim 1, further comprising:
a third cross member that is mounted between the pair of frames at a position in a vehicle front direction compared to the predetermined position in the vehicle front-rear direction, wherein
the motor is disposed on the third cross member.

3. The battery support structure according to claim 1, further comprising:
a restraint member that restrains the battery on a side of the vehicle, wherein
the restraint member is disposed on the frame.

4. The battery support structure according to claim 3, wherein
the restraint member restrains the battery in a state where the battery is drawn toward the side of the vehicle so that, when the battery is drawn toward the side of the vehicle with a predetermined force, the battery receives a reaction force against the predetermined force.

5. The battery support structure according to claim 4, further comprising:
an actuator that transmits, to the restraint member, power for drawing the battery with the predetermined force, wherein
the actuator is disposed on the second cross member.
